(19) United States
(12) Patent Application Publication
(10) Pub. No.: US 2007/0156844 A1
(43) Pub. Date: Jul. 5, 2007

(54) Apparatus and method for storing content, and apparatus and method for displaying content

(75) Inventor: Jung-won Lee, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/647,186

(22) Filed: Dec. 29, 2006

(30) Foreign Application Priority Data
Dec. 29, 2005 (KR) 10-2005-0133158
Nov. 27, 2006 (KR) 10-2006-0117915

(51) Int. Cl. G06F 15/16

(52) U.S. Cl. 709/217

(57) ABSTRACT

Provided are a method and apparatus for storing content, and a method and apparatus for displaying content. The method of displaying content, includes displaying display information representing content, which is stored in a hierarchical information structure based on time information of the content, in the form of timetable; receiving a user input signal for selecting a section providing a piece of display information displayed in the form of time table; and displaying display information, corresponding to a lower layer of the section selected based on the user input signal, in the form of timetable. Accordingly, it is possible to reduce user's inconvenience and time delay caused when a large amount of content is searched for, thereby allowing a user to easily and rapidly detect desired content.

### CROSS-REFERENCE TO RELATED PATENT APPLICATIONS

This application claims priority from Korean Patent Application No. 10-2005-0133158, filed on Dec. 29, 2005, and Korean Patent Application No. 10-2006-0117915, filed on Nov. 27, 2006, in the Korean Intellectual Property Office, the disclosures of which are incorporated herein in their entirety by reference.

### BACKGROUND OF THE INVENTION

1. Field of the Invention

Apparatuses and methods consistent with the present invention relate to storing content and displaying content, and more particularly, to constructing, storing, and providing multimedia content information in the form of hierarchical information structure based on time information of the content.

2. Description of the Related Art

In general, in order to manage a large amount of information, most users organize the information using hierarchical levels. A hierarchical structure of information gradually reduces the range of search, thus increasing the convenience of searching for information more than a plane structure of information.

Research has been conducted into methods of allowing a user to more easily and rapidly search for a large amount of content stored in a multiplicity of devices.

However, in the related art, since a structure of content has a linear form, all content must be searched for to detect even only a piece of content, thereby requiring a lot of time and efforts to search for the desired content.

FIG. 1 is a block diagram illustrating a related art list of stored content and a related art method of displaying the list. Referring to FIG. 1, the list of the stored content is linearly displayed according to the names of content files.

FIG. 2 is a block diagram illustrating a related art method of searching for a list of stored content. In the method of FIG. 2, content files that are linearly arranged are individually viewed and searched for.

As described above, in the related art, since the content is linearly arranged, a screen scroll operation must be performed many times when searching for a large amount of content, thus causing a user's inconvenience and time delay. Further, even when the user searches again for content that was previously searched for, the user cannot rapidly search for the content.

### SUMMARY OF THE INVENTION

The present invention provides a method and apparatus for storing content and a method and apparatus for displaying content, which reduce a user's inconvenience and time delay when searching for a large amount of content that is linearly arranged.

The present invention also provides a computer readable medium having recorded thereon a computer program for executing the methods.

According to an aspect of the present invention, there is provided a method of storing content, the method comprising receiving content; extracting time information of the content; and storing the content in a hierarchical information structure based on the time information of the content.

According to another aspect of the present invention, there is provided an apparatus for storing content, the apparatus comprising an input unit which receives content; a time information extraction unit which extracts time information of the content; and a storage unit which stores the content in a hierarchical information structure based on the time information of the content.

According to another aspect of the present invention, there is provided a method of displaying content, the method comprising extracting display information representing content stored based on a hierarchical information structure based on time information of the content; and displaying the extracted display information in the form of timetable.

According to another aspect of the present invention, there is provided a method of displaying content, the method comprising displaying display information representing content, which is stored in a hierarchical information structure based on time information of the content, in the form of timetable; receiving a user input signal for selecting a section providing a piece of display information displayed in the form of time table; and displaying display information, corresponding to a lower layer of the section selected based on the user input signal, in the form of timetable.

According to another aspect of the present invention, there is provided an apparatus for displaying content, the apparatus comprising a storage unit which stores a plurality of pieces of content in a hierarchical information structure based on time information of the content; a display information management unit which manages displaying information representing the content; and a display unit which displays the display information of the content in the form of timetable.

According to another aspect of the present invention, there is provided a computer readable medium having recorded thereon a computer program for executing a method of storing content according to the exemplary embodiment of the present invention.

According to another aspect of the present invention, there is provided a computer readable medium having recorded thereon a computer program for executing a method of displaying content according to the exemplary embodiment of the present invention.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a block diagram illustrating a related art list of stored content and a related art method of displaying the list;

FIG. 2 is a block diagram illustrating a related art method of searching for a list of stored content;

FIG. 3 is a block diagram of a content storage apparatus according to an exemplary embodiment of the present invention;

FIG. 4 is a flowchart illustrating a method of storing content according to an exemplary embodiment of the present invention;

FIG. 5 illustrates a hierarchical information structure used in the apparatus and method of FIGS. 3 and 4;

FIG. 6 is a block diagram of a content display device according to an exemplary embodiment of the present invention;

FIG. 7 is a flowchart illustrating a method of displaying content according to an exemplary embodiment of the present invention;

FIG. 8 is a flowchart illustrating a method of displaying content according to another exemplary embodiment of the present invention; and

FIGS. 9A through 9D are diagrams illustrating examples of a hierarchical information structure presented in the format of timetable, according to exemplary embodiments of the present invention.

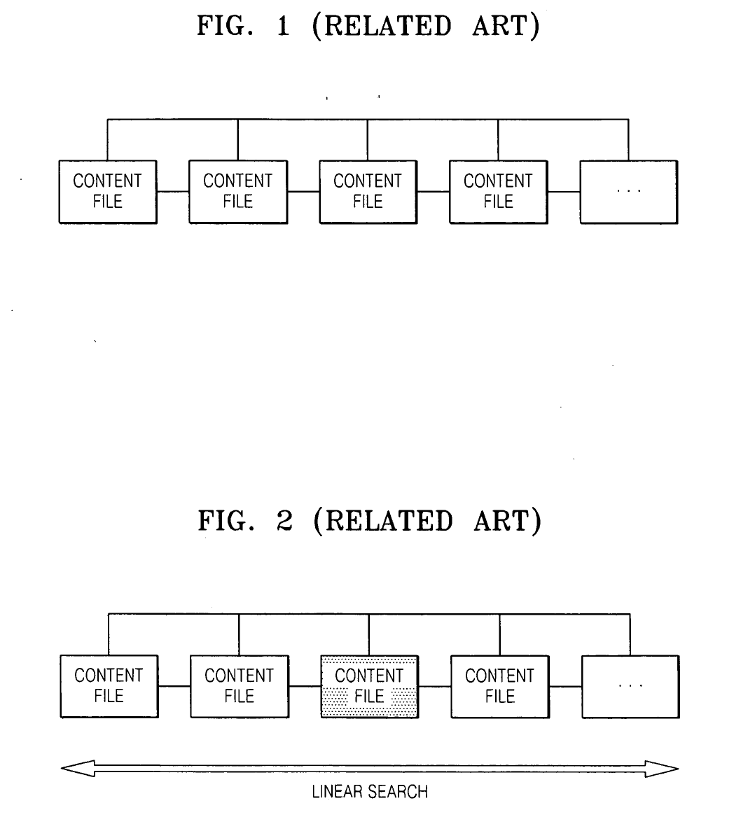

### DETAILED DESCRIPTION OF THE EXEMPLARY EMBODIMENTS OF THE INVENTION

Hereinafter, exemplary embodiments of the present invention will be described in detail with reference to the accompanying drawings.

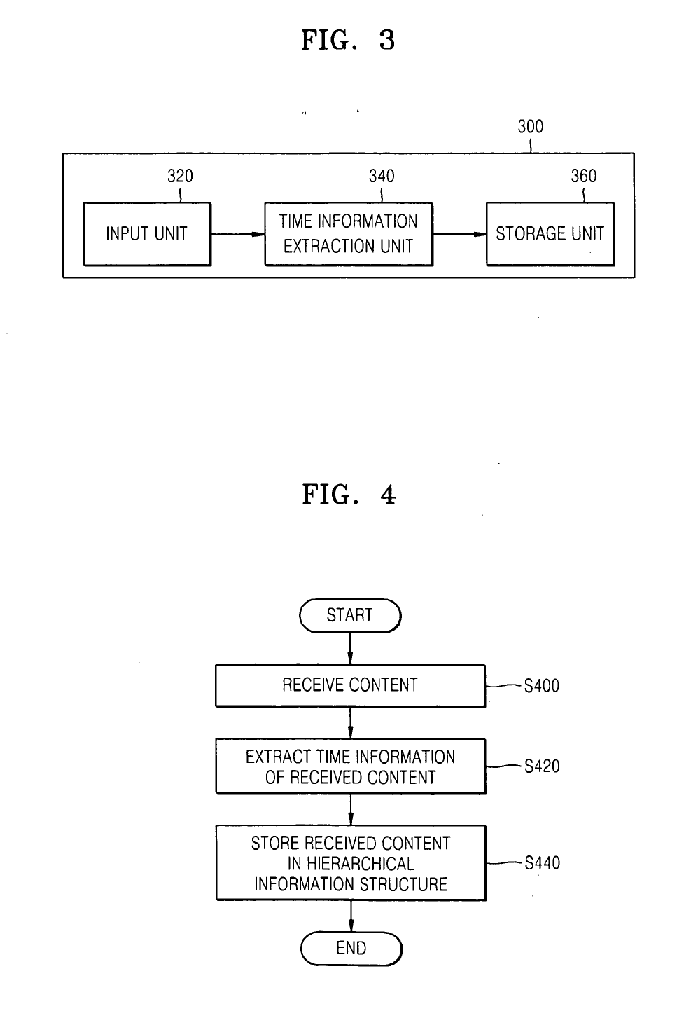

FIG. 3 is a block diagram of a content storage apparatus according to an exemplary embodiment of the present invention. Referring to FIG. 3, the content storage apparatus 300 includes an input unit 320, a time information extraction unit 340, and a storage unit 360.

The input unit 320 receives content via a network or from an external device. The content may be multimedia content or digital content. For example, the content may be broadcast content available to a personal video recorder (PVR) or digital multimedia broadcasting (DMB) that requires content to be categorized according to time. However, the type of the content is not limited to the above example.

The time extraction unit 340 receives the content from the input unit 320 and extracts time information of the content from the content. The time information of the content may be information regarding the time when the content was created or supplied to the input unit 320.

For example, if information regarding the time when the content was created can be extracted, the time extraction unit 340 extracts this information and transmits it to the storage unit 360. If not, the time extraction unit 340 extracts information regarding the time when the content was supplied to the input unit 320 and supplies it to the storage unit 360.

The storage unit 360 receives the time information extracted by the time extraction unit 340, and stores the content in a hierarchical information structure based on the received time information.

Here, the hierarchical information structure is a logical structure allowing content to be stored based on time information regarding the content. In an exemplary embodiment of the present invention, the hierarchical information structure has a tree structure extending in units of year, month, week, and day. The tree structure is constructed such that items are linked to one another in the form of branches of tree. For example, content that was created (or supplied) and stored in the year of 2005 is sorted out and stored in a “year 2005” item of a “year” layer, based on time information. Content, belonging to the “year 2005” item, which was created (or supplied) and stored in December, is sorted out and stored in a “December” item of a “month” layer that is a lower layer linked to the “year 2005” item, based on the time information. Since the content is stored according to the hierarchical time information based on the time information, it is possible to access the content stored according to the hierarchical information structure, using the time information of the content.

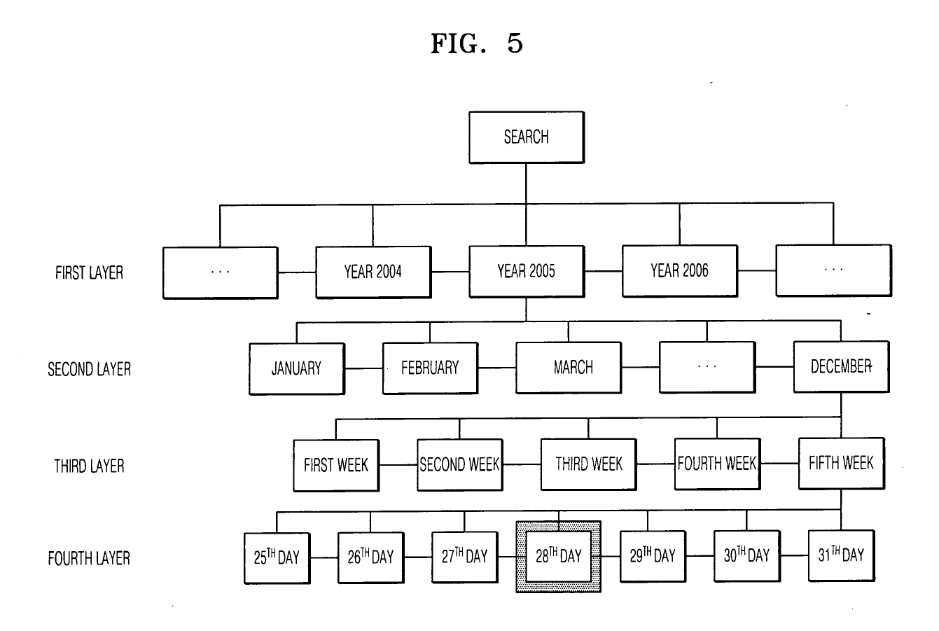

The hierarchical information structure will later be described in detail with reference to FIG. 5.

FIG. 4 is a flowchart illustrating a method of storing content according to an exemplary embodiment of the present invention. Referring to FIG. 4, first, content is received via a network or from an external device (S400).

Here, the content may be multimedia content or digital content. For example, the content may be broadcast content available to a PVR or DMB that requires content to be categorized according to time.

Next, time information of the content is extracted (S420). In operation S420, if information regarding the time when the content was created is available, this information is extracted, and if this information is not available, information regarding the time when the content was received in operation S400 is extracted.

Next, the content is stored in a hierarchical tree structure based on the time information of the content (S440). The hierarchical information structure has a tree structure in units of year, month, week, and day. That is, content that was created (or supplied) and stored in the year of 2005 is sorted out and stored in a “year 2005” item of a “year” layer, and content that was created or supplied and stored in December 2005 is sorted out and stored in a “December” item of a “month” layer that is a lower layer of the “year 2005” item of the “year” layer.

The hierarchical information structure will be described in detail with reference to FIG. 5.

FIG. 5 is a diagram illustrating a hierarchical information structure used in FIGS. 3 and 4. As illustrated in FIG. 5, the hierarchical information structure used in FIGS. 3 and 4 has a hierarchical tree structure. FIG. 5 illustrates a case where a content file that was created (or supplied) and stored on Dec. 28, 2005, is to be executed. Referring to FIG. 5, first through fourth layers are a “year” layer, a “month” layer, a “week” layer, and a “day” layer, respectively. Although not illustrated, a “time” layer may further be included as a fifth layer.

More specifically, for example, in order to detect and execute the content file that was created (or supplied) and stored on Dec. 28, 2005, a user sequentially selects a “year 2005” item of the first layer, a “December” item of the second layer, a “fifth-week” item of the third layer, and a “28^{th} day” item of the fourth layer.

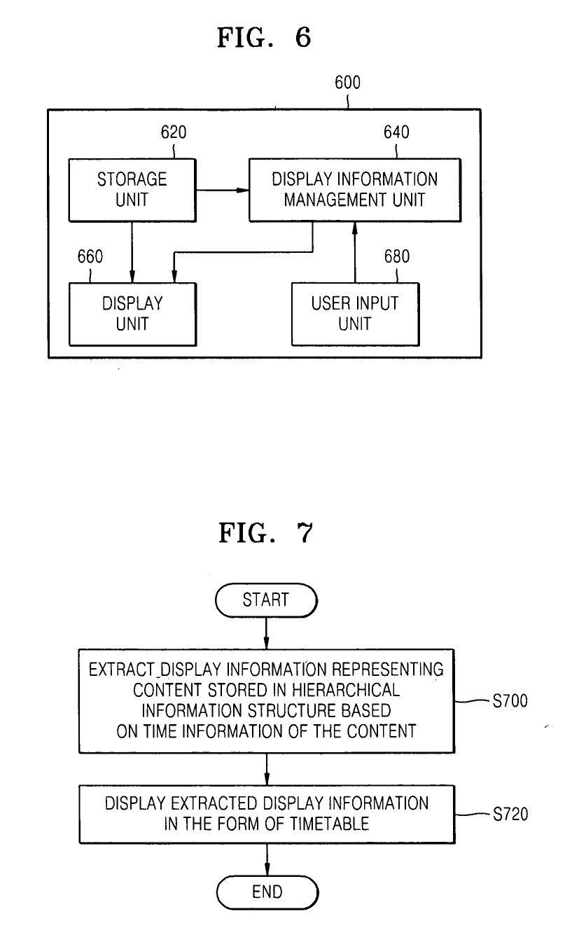

FIG. 6 is a block diagram of an apparatus 600 that displays content according to an exemplary embodiment of the present invention. Referring to FIG. 6, the apparatus 600 includes a storage unit 620, a display information management unit 640, a display unit 660, and a user input unit 680. In an exemplary embodiment of the present invention, the apparatus 600 may further include the content storage apparatus 300 illustrated in FIG. 3. Here, the apparatus 600 will be described in greater detail.

The storage unit 620 stores content in a hierarchical information structure based on time information of content.

Here, the content may be multimedia content or digital content. For example, the content may be broadcast content available to a PVR or DMB that requires content to be categorized according to time.

The display information management unit 640 manages display information for displaying the content stored in the hierarchical information structure in the storage unit 620. When display information for content corresponding to each layer is stored in the storage unit 620, the display information management unit 640 is capable of extracting the display information and inputting it to the display unit 660. The type of the display information is not limited if the display information is related to content included in a corresponding layer.

The display information input to the display unit 660 contains information regarding a representative piece of content categorized into items of each layer of the hierarchical information structure. For example, the display information may contain thumbnail information regarding content representing a predetermined item belonging to each layer of the hierarchical information structure. Also, the display information may contain information regarding a total number of pieces of content belonging to a predetermined item of each layer of the hierarchical information structure. For example, in a picture that provides display information for a “month” layer, it is possible to provide at least one of information regarding a representative piece of content related to a predetermined week of a “month” item, and information regarding the total number of the pieces of the content related to the predetermined week.

The display unit 660 displays the hierarchical information structure, which is stored in the storage unit 620, in the form of timetable by activating the hierarchical information structure with the display information from the display information management unit 640. The shapes of timetable displayed by the display unit 660 are categorized according to layer, and may be changed in various ways. Here, the layers of the hierarchical information structure displayed may be set by a user or be default layers. For example, the display unit 660 may first display the display information corresponding to a “month” layer, which is a first, second layer, in the form of timetable.

The user input unit 680 receives a user input signal. The user input unit 680 inputs to the display information management unit 640 a user input signal for selecting a section providing one of a plurality of pieces of display information presented in the form of timetable. For example, when the display unit 660 first displays display information for a “month” layer (second layer) and a user desires to extend the range of search to a “week” layer (a third layer), the user inputs a user input signal for requesting content information for the third layer, via the user input unit 680.

Upon receiving via the user input unit 680 a user input signal for selecting one from among a plurality of pieces of content presented in the form of timetable, the display information management unit 640 controls the display unit 660 to display information for a lower layer of a layer corresponding to the display information selected based on the user input signal.

FIG. 7 is a flowchart illustrating a method of displaying content according to an exemplary embodiment of the present invention. In an exemplary embodiment of the present invention, the method of FIG. 7 may further include the method of storing content, illustrated in FIG. 4. Here, the method of displaying content will described in greater detail.

Display information related to a hierarchical information structure based on time information of content is extracted (S700). Here, the content may be multimedia content or digital content. For example, the content may be broadcast content applicable to a PVR or DMB that requires content to be categorized according to time. Also, the display information may contain at least one of information related to a representative piece of content that respectively correspond to layers of the hierarchical information structure, and information indicating a total number of the plurality of the pieces of the content.

Next, the extracted display information is displayed in the form of timetable (S720).

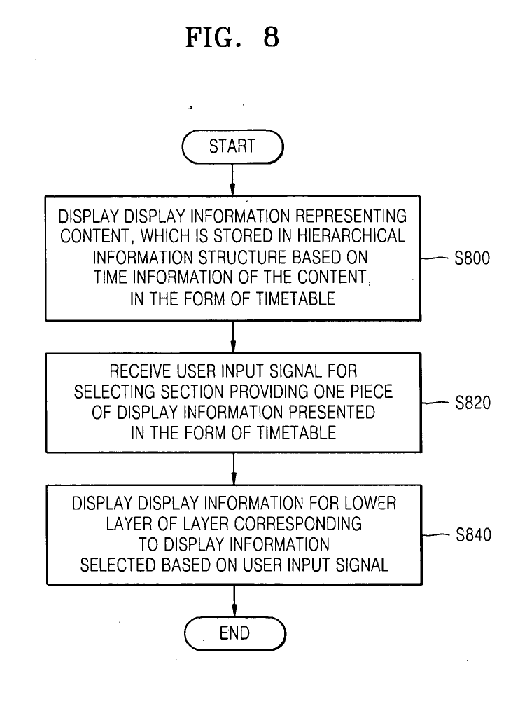

FIG. 8 is a flowchart illustrating a method of displaying content according to another exemplary embodiment of the present invention. First, display information representing content that is stored in a hierarchical information structure based on time information of content, is displayed in the form of timetable (S800). Here, the displayed display information may correspond to a layer, from among layers of the hierarchical information structure, which is set by a user or is a default layer. For example, the display information displayed in operation S800 may correspond to the “month” layer (the second layer) illustrated in FIG. 5.

Next, a user input signal for selecting a section providing one of a plurality of pieces of display information presented in the form of timetable, is received from the user (S820). For example, when display information corresponding to an item belonging to a “month” layer (second layer) is first displayed for each of lattice-shaped section of a timetable, the user may input a user input signal for selecting one of the lattice-shaped sections each providing the display information, and thus, the display information may be selected.

When receiving the user input signal in operation S820, display information for a lower layer of a layer corresponding to the section selected in operation S820 is displayed in the form of timetable (S840).

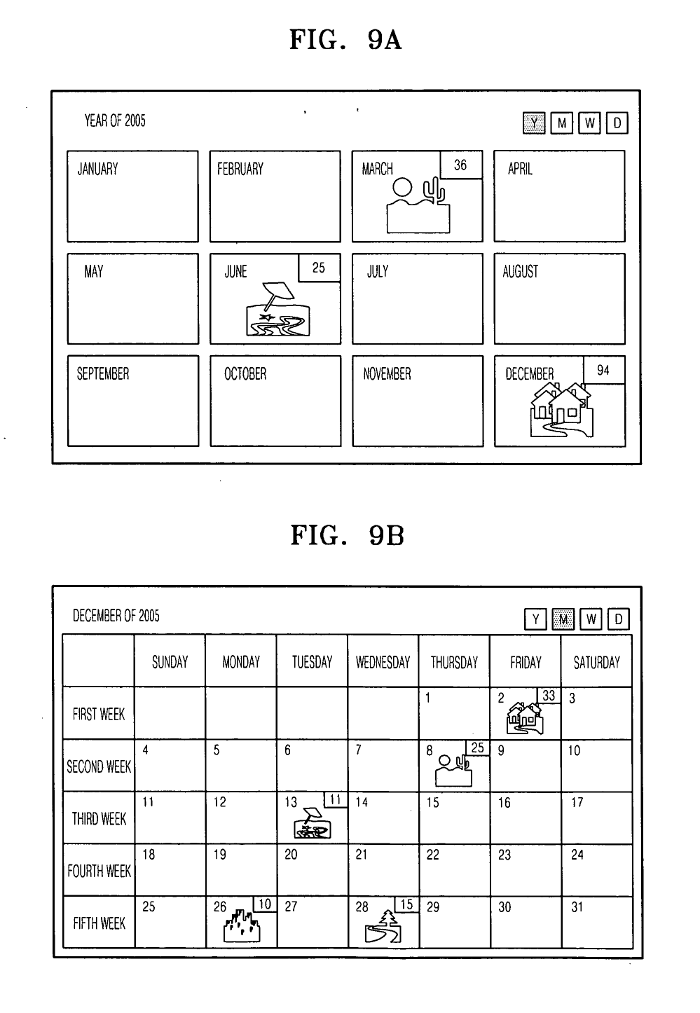

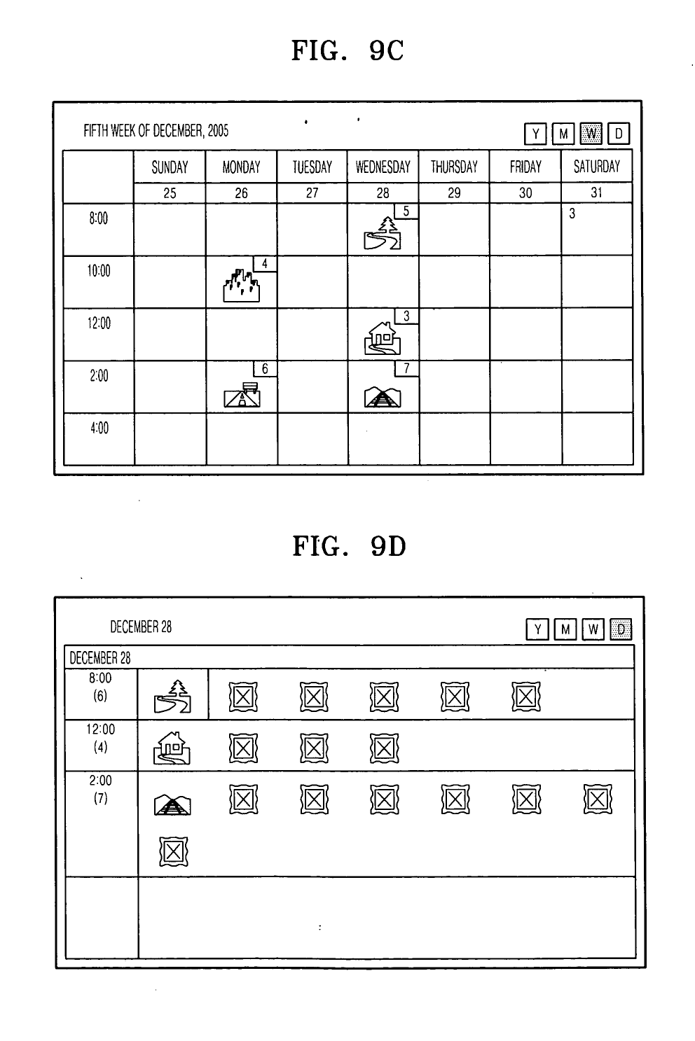

FIGS. 9A through 9D are diagrams illustrating examples of a hierarchical information structure displayed in the form of timetable, according to exemplary embodiments of the present invention. In detail, FIGS. 9A through 9D respectively illustrate in the form of time table a “year” layer (first layer), a “month” layer (second layer) that is a lower layer of the first layer, a “week” layer (third layer) that is a lower layer of the second layer, and a “day” layer (fourth layer) that is a lower layer of the third layer, of the hierarchical information structure.

Referring to FIGS. 9A through 9D, display information is included in a timetable. As display information, information related to a representative piece of a plurality of pieces of content, and information regarding a total number of the pieces of the content are displayed.

Referring to FIG. 9A, display information regarding a “year 2005” layer is displayed. In this case, when a user selects a section corresponding to display information, belonging to the “year 2005” layer, from among display information in order to obtain detailed information regarding a plurality of pieces of content regarding December of 2005, display information for a “December” layer that is a lower layer of the selected display information is displayed in the form of timetable, as illustrated in FIG. 9B. The display information regarding the “December” layer includes display information that is information regarding content regarding each item of each of the weeks of December.

Referring to FIG. 9B, when the user selects display information corresponding to the fifth week of December from among the pieces of the display information regarding the “December” layer in the timetable in order to obtain detailed information regarding a plurality of pieces of content corresponding to the fifth week, display information for a “week” layer, which is a lower layer of a “month” layer, is illustrated as illustrated in FIG. 9C. As the display information corresponding to the “week” layer, display information of content corresponding to days and times belonging to the fifth week is displayed in the form of timetable.

Referring to FIG. 9C, when the user selects display information for the 28^{th} day of December from among the display information of the “week” day in order to obtain detailed information regarding a plurality of pieces of content that are sorted out to belong to the 28^{th} day, display information of a “day” layer regarding the 28^{th} day is displayed, and thus, detailed information regarding the pieces of the content that are sorted out as items of the 28^{th} day is displayed in the form of timetable, as illustrated in FIG. 9D.

Referring to FIG. 9D, five pieces of content, three pieces of content, and seven pieces of content are stored at 8:00 a.m., 12:00 p.m., and 2:00 p.m. on Dec. 28, 2005, respectively.

The present invention can be embodied as computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as a computer readable code in the distributed system.

According to the exemplary embodiments of the present invention, a large amount of content is searched for by using a hierarchical information structure based on time information of the content, and extending the hierarchical information structure in units of layers and by stages. Accordingly, it is possible to reduce user's inconvenience and time delay caused when a large amount of content is searched for, thereby allowing a user to easily and rapidly detect desired content.

The exemplary embodiments of the present invention are applicable not only to an apparatus that stores and reproduces a large scale of multimedia content information but also to an apparatus that effectively classifies, stores, and displays content according to time. For example, the present invention is applicable to a PVR and a DMB apparatus that record and reproduce broadcast content.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of storing content, the method comprising:
receiving content;
extracting time information of the content; and
storing the content in a hierarchical information structure based on the time information of the content.

2. The method of claim 1, wherein the time information of the content comprises a time when the content is created or supplied.

3. The method of claim 1, wherein the hierarchical information structure is hierarchically categorized into units of years, months, weeks, and days.

4. The method of claim 1, wherein the content comprises content for broadcasting.

5. An apparatus for storing content, the apparatus comprising:
an input unit which receives content;
a time information extraction unit which extracts time information of the content; and
a storage unit which stores the content in a hierarchical information structure based on the time information of the content.

6. The apparatus of claim 5, wherein the time information of the content comprises a time when the content is created or supplied.

7. The apparatus of claim 5, wherein the hierarchical information structure is hierarchically categorized into units of years, months, weeks, and days.

8. The apparatus of claim 5, wherein the content comprises content for broadcasting.

9. A method of displaying content, the method comprising:
extracting display information representing content stored based on a hierarchical information structure based on time information of the content; and
displaying the extracted display information in a timetable.

10. The method of claim 9, wherein the time information of the content comprises a time when the content is created or supplied.

11. The method of claim 9, wherein the hierarchical information structure is hierarchically categorized into units of years, months, weeks, and days.

12. The method of claim 9, wherein the content comprises content for broadcasting.

13. The method of claim 9, wherein the display information comprises at least one of:
information related to a piece of content corresponding to items of layers of the hierarchical information structure; and
information regarding a total number of the pieces of the content corresponding to the items of the layers of the hierarchical information structure.

14. A method of displaying content, comprising:
displaying display information representing content, which is stored in a hierarchical information structure based on time information of the content, in a timetable;
receiving a user input signal for selecting a section of the display information displayed in the form of time table; and
displaying lower layer display information, corresponding to a lower layer of the section selected based on the user input signal, in a second timetable.

15. The method of claim 14, wherein the time information of the content comprises a time when the content is created or supplied.

16. The method of claim 14, wherein the hierarchical information structure is hierarchically categorized into units of years, months, weeks, and days.

17. The method of claim 14, wherein the content is content for broadcasting.

18. The method of claim 14, wherein the display information comprises at least one of:
information related to a piece of content corresponding to items of layers of the hierarchical information structure; and
information regarding a total number of the pieces of the content corresponding to the items of the layers of the hierarchical information structure.

19. An apparatus for displaying content, comprising:
a storage unit which stores a plurality of pieces of content in a hierarchical information structure based on time information of the content;
a display information management unit which manages displaying information representing the content; and
a display unit which displays the display information of the content in a timetable.

20. The apparatus of claim 19, further comprising a user input unit which receives a user input signal,
wherein, if a user input signal for selecting a section of the display information displayed in the timetable is received via the user input unit, the display information management unit controls the display unit to display lower layer display information for a lower layer of a layer corresponding to the section selected based on the user input signal.

21. The apparatus of claim 19, wherein the time information of the content comprises a time when the content is created or supplied.

22. The apparatus of claim 19, wherein the hierarchical information structure is hierarchically categorized into units of years, months, weeks, and days.

23. The apparatus of claim 19, wherein the content comprises content for broadcasting.

24. The apparatus of claim 19, wherein the display information comprises at least one of:
information related to a piece of content corresponding to items of layers of the hierarchical information structure; and
information regarding a total number of the pieces of the content corresponding to the items of the layers of the hierarchical information structure.

25. A computer readable medium having recorded thereon a computer program for executing the method of claim 1.

26. A computer readable medium having recorded thereon a computer program for executing the method of claim 9.

27. A computer readable medium having recorded thereon a computer program for executing the method of claim 14.
